(19) United States
(12) Patent Application Publication
(10) Pub. No.: US 2015/0052319 A1
(43) Pub. Date: Feb. 19, 2015

(54) MEMORY MANAGEMENT METHODS AND SYSTEMS FOR PAGE-OUT MECHANISM

(71) Applicant: HTC Corporation, Taoyuan County (TW)

(72) Inventors: Abhishek SAXENA, Taoyuan County (TW); Chien-Lung CHOU, Taoyuan County (TW); Chun-Hao FAN, Taoyuan County (TW); Wei-Chun CHEN, Taoyuan County (TW); Chia-Wei CHEN, Taoyuan County (TW)

(73) Assignee: HTC Corporation, Taoyuan County (TW)

(21) Appl. No.: 13/967,362

(22) Filed: Aug. 15, 2013

(51) Int. Cl. G06F 12/02

(52) U.S. Cl. CPC G06F 12/0253; G06F 2212/69
USPC 711/160

(57) ABSTRACT

Memory management methods and systems for page-out mechanism are provided. A page-out mechanism is performed via an OS (Operating System) based on a parameter of the page-out mechanism, wherein the page-out mechanism moves data from a memory to a storage unit. A usage of a page-out partition in the storage unit is monitored. The parameter of the page-out mechanism is dynamically set according to the usage of the page-out partition, wherein when the usage is increased, the parameter of the page-out mechanism is decreased, and when the usage is decreased, the parameter of the page-out mechanism is increased.

### BACKGROUND OF THE INVENTION

1. Field of the Invention

The disclosure relates generally to memory management methods and systems, and, more particularly to memory management methods and systems that control the performance endurance for page-out mechanism.

2. Description of the Related Art

Recently, portable devices, such as handheld devices, have become more and more technically advanced and multifunctional. For example, a handheld device may have telecommunications capabilities, e-mail message capabilities, an advanced address book management system, a media playback system, and various other functions. Due to increased convenience and functions of the devices, these devices have become necessities of life.

As more and more applications become richer and number of published applications grows significantly on a mobile device which is generally coupled with limited physical memory, the situation of Out-Of-Memory (OOM) is met in higher probabilities and needs to be addressed carefully. The modern Operating System (OS) for mobile device monitors memory usage level, and as soon as the level rises above the predefined threshold, the built-in memory management component takes the actions instantly, ex., garbage collection to reclaim unused memory, kill the applications either randomly or based on sonic simple strategies like application size, application age or creation time.

Further, some OSs may have page-out mechanism, in which they move least recently pages or unused pages from a memory, such as RAM (Random-Access Memory) to a storage unit, such as Flash memory to free the system RAM. It is understood that, data in the memory are always recorded in a page manner. It is noted that, since life cycle is a big limitation with Flash memory, for example, the number of writes to storage is limited, and the page-out mechanism needs large space on storage, the page-out mechanism will hurt the storage endurance, thereby making the flash memory die soon. Additionally, the page-out mechanism will damage the system performance, especially, once the storage is full. When the page-out partition in the storage is full, the system performance will significantly get dropped.

### BRIEF SUMMARY OF THE INVENTION

Memory management methods and systems for page-out mechanism are provided.

In an embodiment of a memory management method for page-out mechanism, a page-out mechanism is performed via an OS (Operating System) based on a parameter of the page-out mechanism, wherein the page-out mechanism moves data from a memory to a storage unit. A usage of a page-out partition in the storage unit is monitored. The parameter of the page-out mechanism is dynamically set according to the usage of the page-out partition, wherein when the usage is increased, the parameter of the page-out mechanism is decreased, and when the usage is decreased, the parameter of the page-out mechanism is increased.

An embodiment of a memory management system for page-out mechanism includes a memory, a storage unit including a page-out partition, and a processing unit. The processing unit performs a page-out mechanism via an OS (based on a parameter of the page-out mechanism, wherein the page-out mechanism moves data from the memory to the page-out partition in the storage unit. The processing unit monitors a usage of the page-out partition in the storage unit, and dynamically sets the parameter of the page-out mechanism according to the usage of the page-out partition. When the usage is increased, the parameter of the page-out mechanism is decreased. When the usage is decreased, the parameter of the page-out mechanism is increased.

In an embodiment of a memory management method for page-out mechanism, a usage of a page-out partition for a page-out mechanism in a storage unit is monitored, wherein the page-out mechanism moves data from a memory to the page-out partition in the storage unit. A parameter of the page-out mechanism is dynamically set according to the usage of the page-out partition, wherein when the usage is above a first level, the parameter of the page-out mechanism is set as a first value, and when the usage is under a second level, the parameter of the page-out mechanism is set as a second value, in which the first level is greater than the second level, and the second value is greater than the first value.

In some embodiments, When the usage is greater than a third level, the parameter of the page-out mechanism is set as a third value, in which the third level is greater than the first level, and the first value is greater than the third value

In some embodiments, the parameter of the page-out mechanism is initially set as a specific value. In some embodiments, the specific value equals to the second value.

In some embodiments, the parameter is the aggressiveness of the page-out mechanism.

Memory management methods for page-out mechanism may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a memory management system for page-out mechanism of the invention;

FIG. 2 is a flowchart of an embodiment of a memory management method for page-out mechanism of the invention;

FIG. 3 is a flowchart of an embodiment of a method for dynamically adjusting parameter based on usage of page-out partition of the invention;

FIG. 4 is a flowchart of another embodiment of a method for dynamically adjusting parameter based on usage of page-out partition of the invention; and

FIG. 5 is a flowchart of another embodiment of a method for dynamically adjusting parameter based on usage of page-out partition of the invention.

### DETAILED DESCRIPTION OF THE INVENTION

Memory management methods and systems for page-out mechanism are provided.

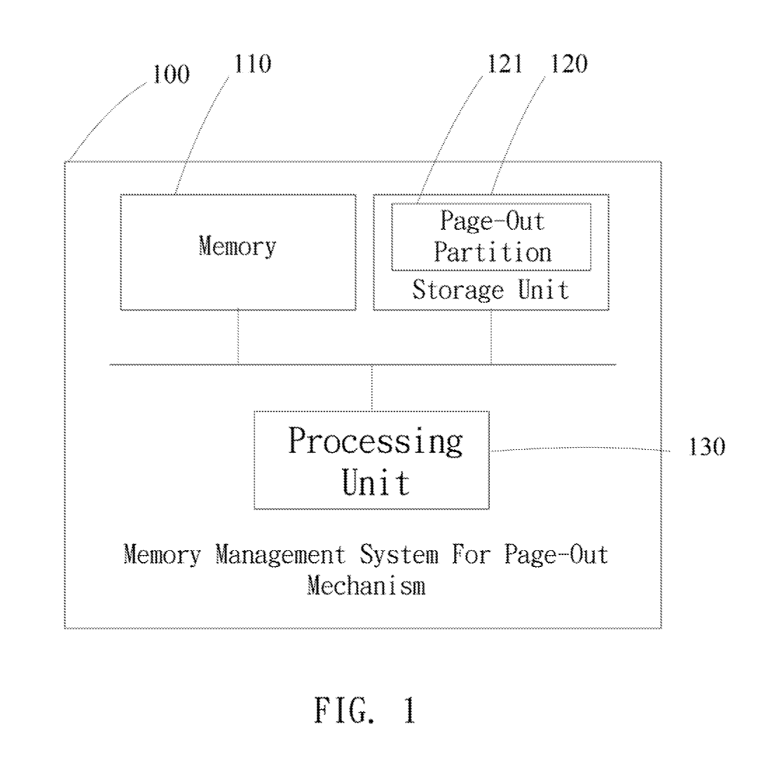

FIG. 1 is a schematic diagram illustrating an embodiment of a memory management system for page-out mechanism of the invention. The memory management system for page-out mechanism 100 can be used in an electronic device, such as mobile devices such as a PDA (Personal Digital Assistant), a smart phone, a mobile phone, an MID (Mobile Internet Device, MID), a Netbook, a GPS (Global Positioning System), or other handheld devices.

The memory management system for page-out mechanism 100 comprises a memory 110, a storage unit 120, and a processing unit 130. The memory 110 can record related codes and/or data corresponding to processes/applications running on a system of the electronic device. The storage unit 120 comprises a page-out partition 121, used for record data, always in a page manner, moved from the memory 110 by a page-out mechanism. It is noted that, an OS may be installed on the electronic device, and a kernel of the OS is always recorded in the memory. The OS can execute the page-out mechanism to move data from the memory 110 to the page-out partition in the storage unit 120. It is understood that, the OS executes the page-out mechanism based on a parameter of the page-out mechanism. The parameter may be aggressiveness of the page-out mechanism. It is noted that, the parameter value is between 0˜100, in which when the parameter value is higher, the OS is more aggressive to move data pages hum the memory 110 to the page-out partition 121 in the storage unit 120. The processing unit 130 can control related components of the memory management system for page-out mechanism 100, and perform the memory management methods for page-out mechanism of the invention, which will be discussed further in the following paragraphs.

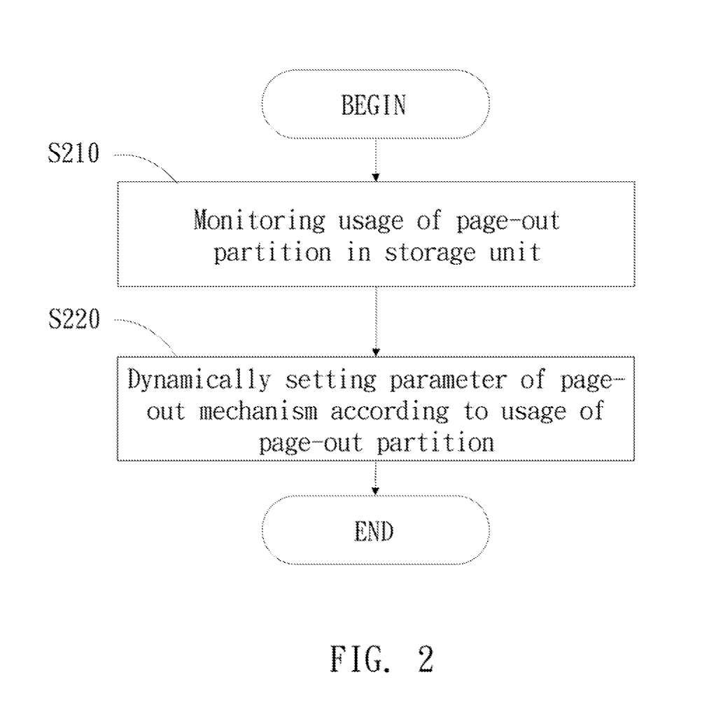

FIG. 2 is a flowchart of an embodiment of a memory management method for page-out mechanism of the invention. The memory management method for page-out mechanism can be used in an electronic device, such as mobile devices such as a PDA, a smart phone, a mobile phone, an MID, a Netbook, a GPS, or other handheld devices. In step S210, a usage of the page-out partition in the storage unit is monitored. It is understood that, since several processes/applications can be executed on the device, and the page-out mechanism may be performed by the OS, the usage of the page-out partition can be dynamically changed. Then, in step S220, the parameter, such as aggressiveness of the page-out mechanism is dynamically set according to the usage of the page-out partition. After the adjustment of the parameter, the OS can execute the page-out mechanism based on the adjusted parameter.

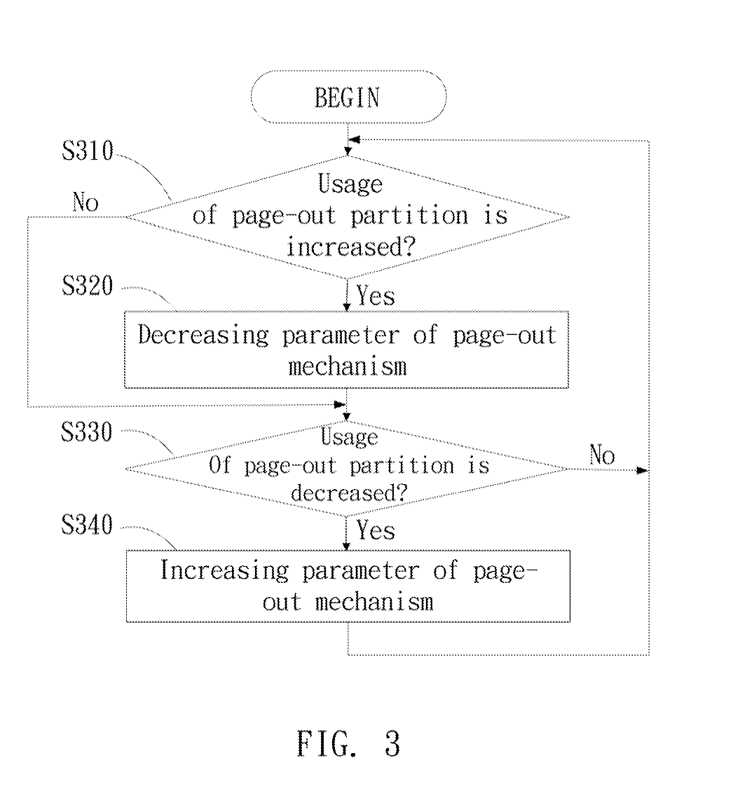

FIG. 3 is a flowchart of an embodiment of a method for dynamically adjusting parameter based on usage of page-out partition of the invention.

In step S310, it is determined whether the usage of the page-out partition is increased. When the usage of the page-out partition is not increased (No in step S310), the procedure goes to step S330. When the usage of the page-out partition is increased (Yes in step S310), in step S320, the parameter of the page-out mechanism is decreased. As described, the parameter value may be between 0˜100, in which when the parameter value is higher, the OS is more aggressive to move data pages from the memory to the page-out partition in the storage unit. Then, in step S330, it is determined whether the usage of the page-out partition is decreased. When the usage of the page-out partition is not decreased (No in step S330), the procedure returns to step S310. When the usage of the page-out partition is decreased (Yes in step S330), in step S340, the parameter of the page-out mechanism is increased.

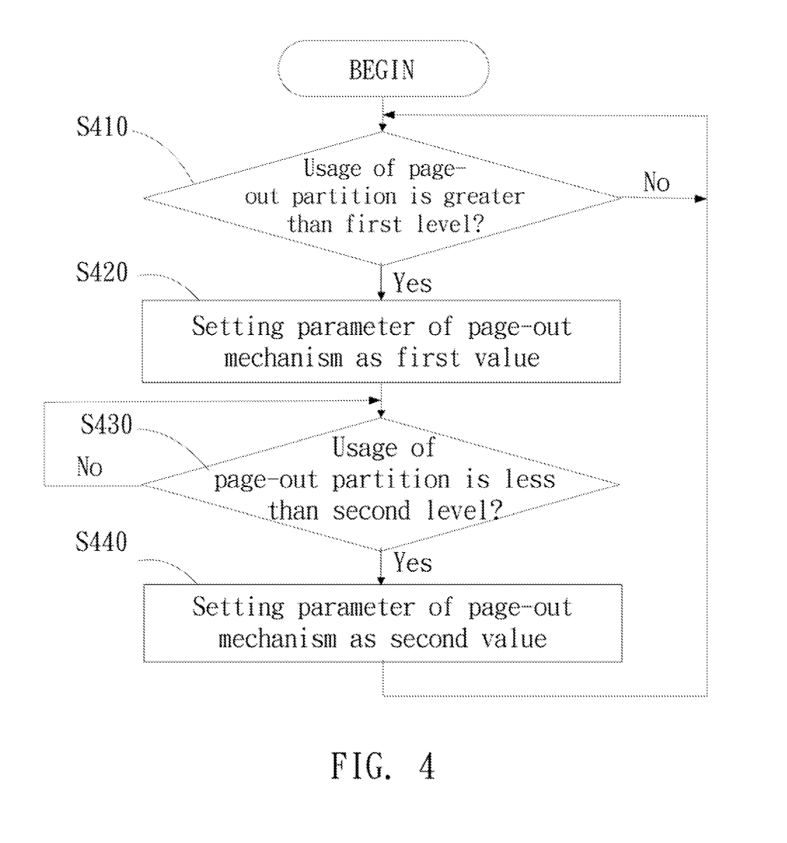

FIG. 4 is a flowchart of another embodiment of a method for dynamically adjusting parameter based on usage of page-out partition of the invention.

In step S410, it is determined whether the usage of the page-out partition is greater than a first level. It is understood that, the first level may be a specific value or percentage. When the usage of the page-out partition is not greater than the first level (No in step S410), the procedure remains at step S410. When the usage of the page-out partition is greater than the first level (Yes in step S410), in step S420, the parameter of the page-out mechanism is set as a first value. As described, the parameter value ma may be between 0˜100, in which when the parameter value is higher, the OS is more aggressive to move data pages from the memory to the page-out partition in the storage unit. Then, in step S430, it is determined whether the usage of the page-out partition is less than a second level. Similarly, the second level may be a specific value or percentage. It is noted that, the first level is greater than the second level. When the usage of the page-out partition is not less than the second level (No in step S430) the procedure remains at step S430. When the usage of the page-out partition is less than the second level (Yes in step S430), in step S440, the parameter of the page-out mechanism is set as a second value. It is understood that, the second value is greater than the first value. Then, the procedure goes to step S410.

It is understood that, in some embodiments, the parameter of the page-out mechanism can be initially set as a specific value. In some embodiments, the specific value may equal to the second value.

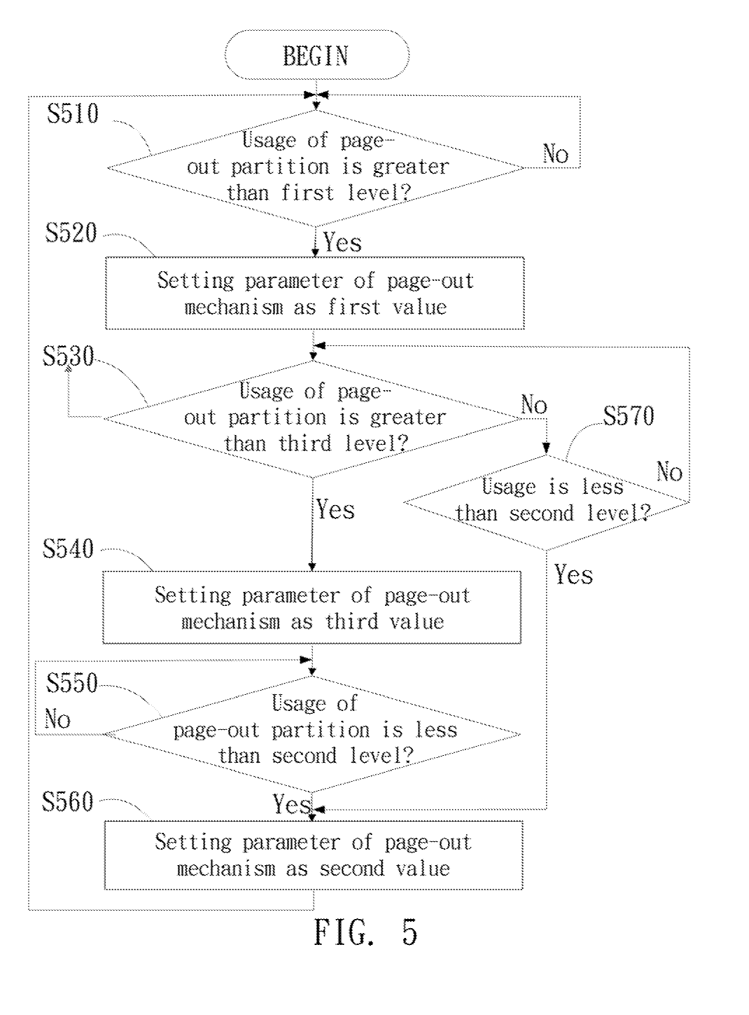

FIG. 5 is a flowchart of another embodiment of a method for dynamically adjusting parameter based on usage of page-out partition of the invention.

In step S510, it is determined whether the usage of the page-out partition is greater than a first level. It is noted that, the first level may be a specific value or percentage. When the usage of the page-out partition is not greater than the first level (No in step S510), the procedure remains at step S510. When the usage of the page-out partition is greater than the first level (Yes in step S510), in step S520, the parameter of the page-out mechanism is set as a first value. As described, the parameter value may be between 0˜100, in which when the parameter value is higher, the OS is more aggressive to move data pages from the memory to the page-out partition in the storage unit. In step S530, it is determined whether the usage of the page-out partition is greater than a third level. Similarly, the third level may be a specific value or percentage. It is noted that, the third level is greater than the first level. When the usage of the page-out partition is not greater than the third level (No in step S530), the procedure goes to step S570, and in step S570, it is determined whether the usage of the page-out partition is less than a second level. Similarly, the second level may be a specific value or percentage. It is noted that, the first level is greater than the second level. When the usage of the page-out partition is not less than the second level (No in step S570), the procedure returns to step S530. When the usage of the page-out partition is less than the second level (Yes in step S570), in step S560, the parameter of the page-out mechanism is set as a second value. It is understood that, the second value is greater than the first value. When the usage of the page-out partition is greater than the third level (Yes in step S530), in step S540, the parameter of the page-out mechanism is set as a third value. It is understood that, the first value is greater than the third value. Then, in step S550, it is determined whether the usage of the page-out partition is less than the second level. When the usage of the page-out partition is not less than the second level (No in step S550), the procedure remains at step S550. When the usage of the page-out partition is less than the second level (Yes in step S550), in step S560, the parameter of the page-out mechanism is set as a second value. As described, the second value is greater than the first value. Then, the procedure goes to step S510.

Similarly, in some embodiments, the parameter of the page-out mechanism can be initially set as a specific value. In some embodiments, the specific value may equal to the second value.

Therefore, the memory management methods and systems for page-out mechanism can monitor the usage of the page-out partition, and dynamically adjusting the parameter of the page-out mechanism based on the monitored usage, thereby properly controlling the performance endurance.

Memory management methods for page-out mechanism, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A memory management method for page-out mechanism for use in an electronic device, comprising:
performing a page-out mechanism via an OS (Operating System) based on a parameter of the page-out mechanism, wherein the page-out mechanism moves data from a memory to a storage unit;
monitoring a usage of a page-out partition in the storage unit; and
dynamically setting the parameter of the page-out mechanism according to the usage of the page-out partition,
wherein when the usage is increased, the parameter of the page-out mechanism is decreased, and when the usage is decreased, the parameter of the page-out mechanism is increased.

2. The method of claim 1, wherein when the usage is greater than a first level, the parameter of the page-out mechanism is set as a first value, and when the usage is less than a second level, the parameter of the page-out mechanism is set as a second value, in which the first level is greater than the second level, and the second value is greater than the first value.

3. The method of claim 2, wherein when the usage is greater than a third level, the parameter of the page-out mechanism is set as a third value, in which the third level is greater than the first level, and the first value is greater than the third value.

4. The method of claim 1, further comprising initially setting the parameter of the page-out mechanism as a specific value, wherein the specific value equals to the second value.

5. The method of claim 1, wherein the parameter comprises aggressiveness of the page-out mechanism.

6. A memory management system for page-out mechanism for use in an electronic device, comprising:
a memory:
a storage unit comprising a page-out partition; and
a processing unit performing a page-out mechanism via an OS (Operating System) based on a parameter of the page-out mechanism, wherein the page-out mechanism moves data from the memory to the page-out partition in the storage unit, monitoring a usage of the page-out partition in the storage unit, and dynamically setting the parameter of the page-out mechanism according to the usage of the page-out partition,
wherein when the usage is increased, the parameter of the page-out mechanism is decreased, and when the usage is decreased, the parameter of the page-out mechanism is increased.

7. The system of claim 6, wherein when the usage is greater than a first level, the processing unit sets the parameter of the page-out mechanism as a first value, and when the usage is less than a second level, the processing unit sets the parameter of the page-out mechanism as a second value, in which the first level is greater than the second level, and the second value is greater than the first value.

8. The system of claim 7, wherein when the usage is greater than a third level, the processing unit sets the parameter of the page-out mechanism as a third value, in which the third level is greater than the first level, and the first value is greater than the third value.

9. The system of claim 6, wherein the processing unit initially sets the parameter of the page-out mechanism as a specific value, in which the specific value equals to the second value.

10. The system of claim 6, wherein the parameter comprises aggressiveness of the page-out mechanism.

11. A machine-readable storage medium comprising a computer program, which, when executed, causes a device to perform a memory management method for page-out mechanism, wherein the method comprises:
performing a page-out mechanism via an OS (Operating System) based on a parameter of the page-out mechanism, wherein the page-out mechanism moves data from a memory to a storage unit;
monitoring a usage of a page-out partition in the storage unit; and
dynamically setting the parameter of the page-out mechanism according to the usage of the page-out partition, wherein when the usage is increased, the parameter of the page-out mechanism is decreased, and when the usage is decreased, the parameter of the page-out mechanism is increased.

12. A memory management method for page-out mechanism tor use in an electronic device, comprising:
monitoring a usage of a page-out partition for a page-out mechanism in a storage unit, wherein the page-out mechanism moves data from a memory to the page-out partition in the storage unit; and
dynamically setting a parameter of the page-out mechanism according to the usage of the page-out partition,
wherein when the usage is above a first level, the parameter of the page-out mechanism is set as a first value, and when the usage is under a second level, the parameter of the page-out mechanism is set as a second value, in which the first level is greater than the second level, and the second value is greater than the first value.

13. The method of claim 12, wherein when the usage is above a third level, the parameter of the page-out mechanism is set as a third value, in which the third level is greater than the first level, and the first value is greater than the third value.

14. The method of claim 12, wherein the parameter comprises aggressiveness of the page-out mechanism.

15. A machine-readable storage medium comprising a computer program, which, when executed, causes a device to perform a memory management method for page-out mechanism wherein the method comprises:
monitoring a usage of a page-out partition for a page-out mechanism in a storage unit, wherein the page-out mechanism moves data from a memory to the page-out partition in the storage unit; and
dynamically setting a parameter of the page-out mechanism according to the usage of the page-out partition,
wherein when the usage is above a first level, the parameter of the page-out mechanism is set as a first value, and when the usage is under a second level, the parameter of the page-out mechanism is set as a second value, in which the first level is greater than the second level, and the second value is greater than the first value.
